(19) United States
(12) Patent Application Publication
(10) Pub. No.: US 2024/0376974 A1
(43) Pub. Date: Nov. 14, 2024

(54) Transmission for a Vehicle, Drive Train, and Method for Installing Such a Transmission

(71) Applicant: ZF Friedrichshafen AG, Friedrichshafen (DE)

(72) Inventor: Tamas Gyarmati, Bermatingen (DE)

(21) Appl. No.: 18/659,458

(22) Filed: May 9, 2024

(30) Foreign Application Priority Data
May 10, 2023 (DE) 102023204340.8

(51) Int. Cl. F16H 57/021; F16H 48/10; F16H 48/38; F16H 57/08

(52) U.S. Cl. CPC F16H 57/021; F16H 48/10; F16H 57/082; F16H 2048/382

(57) ABSTRACT

A transmission (3) for a drive train (2) of a vehicle (1) includes a differential (7) configured to divide a drive power onto a first output shaft (5) and onto a second output shaft (6). The second output shaft (6) is at least indirectly rotatably mounted via a first bearing element (L1) on a housing part (11). The first bearing element (L1) is axially secured on the second output shaft (6) via a first axial securing retainer (A1) and a first axial stop (X1). The first bearing element (L1) is axially secured on the housing part (11) via a second axial securing retainer (A2) and a second axial stop (X2). The second axial securing retainer (A2) is a separate retaining element that is screwed on the housing part (11).

### CROSS-REFERENCE TO RELATED APPLICATION

The present application is related and has right of priority to German Patent Application No. DE102023204340.8 filed on May 10, 2023, which is incorporated by reference in its entirety for all purposes.

### TECHNICAL FIELD

The invention relates generally to a transmission for a drive train of a vehicle, and to a drive train having such a transmission. The invention also relates generally to a method for installing such a transmission.

### BACKGROUND

DE 10 2013 215 877 B4 describes an epicyclic gear train for branching the drive power which is applied at a power input onto a first power output and onto a second power output in conjunction with reducing the output rotational speed to a rotational speed level which is lower than the input rotational speed at the power input. The epicyclic gear train has a first planetary gear stage, which includes a first sun gear, a first planetary gear set, a first planet carrier and a first ring gear. The epicyclic gear train also has a second planetary gear stage, which includes a second sun gear, a second planetary gear set, a second planet carrier and a second ring gear. The epicyclic gear train also has a third planetary gear stage, which includes a third sun gear, a third planetary gear set, a third planet carrier and a third ring gear. The first sun gear acts as a power input, and the first planet carrier is connected to the second sun gear for conjoint rotation. The second planet carrier is fixed in position, the first ring gear is connected to the third sun gear for conjoint rotation and the third ring gear is connected to the second planet carrier for conjoint rotation. A first power output is brought about via the third planetary gear stage, and a second power output is brought about via the second ring gear of the second planetary gear stage.

In known transmissions, the fixed roller bearing, which rotatably supports one of the output shafts at the housing or at a component which is secured to the housing, is placed loosely at the outer diameter into the housing or into the component which is secured to the housing and, at the inner diameter, is mounted onto the output shaft via an interference fit. It is necessary in this case, due to geometric reasons, that the roller bearing be installed in the housing first. Subsequent thereto, the output shaft can be press-fit into the roller bearing and axially secured. This can result in damage to the bearing or surrounding components not least due to the tight installation space.

### BRIEF SUMMARY

Example aspects of the present invention provide a compact transmission for a drive train, which transmission can be simply and securely installed. In particular, final mounting of the transmission is to be simplified.

Example aspects of the invention relate to a transmission for a drive train of a vehicle, the transmission including a differential, which is designed to divide a drive power onto a first output shaft and a second output shaft. The second output shaft is at least indirectly rotatably mounted on a housing part via a first bearing element. The first bearing element is axially secured on the second output shaft via a first axial securing retainer and a first axial stop, and the first bearing element is axially secured on the housing part via a second axial securing retainer and a second axial stop. The second axial securing retainer being a separate retaining element, which is screwed on the housing part.

The differential is designed to be operatively arranged, when the drive train is installed, between an input shaft as well as a first output shaft and a second output shaft. The differential divides a drive power, which is applied at the input shaft and is introduced from a drive unit, in particular an electric machine, into the transmission, onto the two output shafts. The output shafts therefore act as output shafts of the transmission.

A “shaft” is to be understood to be a rotatable component of the transmission, via which associated components of the transmission are connected to one another for conjoint rotation. The shaft can connect the components to one another axially or radially or even both axially and radially. A shaft is not to be understood as exclusively meaning a, for example, cylindrical, rotatably mounted machine element for transmitting torques, but rather general connecting elements which connect individual components or elements to one another, in particular, connecting elements which connect multiple elements to one another for conjoint rotation.

In the framework of this invention, the term “bearing element” is to be understood as meaning the various integral parts of a bearing, or of a bearing assembly. This includes outer rings and inner rings of a radial bearing, bearing shells of an axial bearing, and rolling elements such as, for example, balls or cylindrical rolling elements. Preferably, the bearing elements described in example aspects of this invention are radial bearings.

The first bearing element is preferably a fixed bearing in the form of a grooved ball bearing, via which the second output shaft is mounted for rotation with respect to the housing part. The housing part is fixed in place. Accordingly, the outer ring of the first bearing element is non-rotatably mounted on the housing part and is axially secured, and the inner ring, which is mounted on the second output shaft for conjoint rotation, is mounted so as to be rotatable relative to the outer ring.

Further bearing elements can also be provided in the transmission. Among other things, the two output shafts can be mounted via a second bearing element so as to be rotatable with respect to each other. This second bearing element can be a floating bearing or a fixed bearing. Alternatively or additionally, the second output shaft is rotatably mounted on the housing part via a third bearing element, the third bearing element being a floating bearing.

Bearing elements in the form of fixed bearings are provided for absorbing axial forces in both directions. In addition to the axial forces, the fixed bearing also absorbs radial forces and transfers these onto adjacent components. By fixed bearings, meshing forces arising from helically-toothed gear wheels can be absorbed and transmitted further. No axial or radial play, or only a very slight amount of axial or radial play, arises at the fixed bearing. The axial position of the supported component is precisely defined by the fixed bearing. This applies, in particular, under load. In addition, the movement of the component supported by the fixed bearing is highly precise. The fixed bearing preferably includes one or multiple roller bearing(s), in particular ball bearings. Floating bearings, as compared to fixed bearings, are designed only for absorbing and further transmitting radial forces. These can be needle bearings or cylindrical roller bearings without ribs. Plain bearings are also conceivable.

The “axial stop” is provided for establishing an axial position of the second output shaft relative to the housing part. The precise axial position of the first bearing element in the transmission is determined via the respective axial stop. When the transmission is installed, the first bearing element is guided up to the respective axial stop and secured in axial position by the associated axial securing retainer. The respective axial stop can already be created in a simple way by a radial projection on the respective housing part, or on the first output shaft. Support elements such as, for example, ring elements, which implement an axial stop can also be provided, however.

The separate retaining element is provided for axially securing the first bearing element on the housing part only once a preassembled unit has been installed, the preassembled unit including the first output shaft and the first bearing element, which is preinstalled thereon. In contrast to securing rings which are known from the prior art and which are provided for axially securing the first bearing element, the first bearing element in this case is axially fastened and secured with the separate retaining element, which is preferably in the form of a retaining plate which can be simply and thus cost-effectively produced. The retaining element is fastened on the housing by screws. As a result, installation of the transmission is considerably simplified, since, for example, a press fit can be established between the first bearing element and the first output shaft before the first bearing element is fastened on the housing part and axially secured. The risk of components becoming damaged during the process of installing the transmission is therefore considerably reduced.

In this sense, the separate retaining element is a retaining plate which is screwed on the housing part. A screw connection is to be understood as a separable screw connection. The retaining plate is preferably arranged spatially between the housing part and the carrier element. The retaining plate comes to rest against the end face of the housing part and thus, due to the flat design, allows for a substantially installation-space-neutral arrangement.

In principle, the differential can have any design. Preferably, the differential is an integral differential, which has a first planetary gear set and at least one second planetary gear set, which is operatively connected to the first planetary gear set, wherein a first output torque is at least indirectly transmittable onto the first output shaft by the first planetary gear set of the differential, and a support torque of the first planetary gear set is convertible in the second planetary gear set of the differential such that a second output torque, which corresponds to the first output torque, is transmittable onto the second output shaft.

An “integral differential” is to be understood in the framework of this invention to be a differential which has a first planetary gear set and at least one second planetary gear set, which is operatively connected to the first planetary gear set, wherein the first planetary gear set is drivingly connected to the input shaft, to the second planetary gear set and at least indirectly to the first output shaft. In addition, the second planetary gear set is drivingly connected to the second output shaft. The input torque at the input shaft is convertible by such an integral differential and is divisible and transmittable at a defined ratio onto the two output shafts. Preferably fifty percent (50%), i.e., half, of the input torque is transmitted onto each of the output shafts. Therefore, the differential does not have a component that is subjected to both output torques. In other words, the two torques are never combined. Furthermore, the differential has no gears that rotate in a block, or without a rolling motion, when the output rotational speeds of the output shafts are identical. Therefore, there is always relative movement of the intermeshed components of the differential regardless of the output rotational speeds of the output shafts.

A “planetary gear set” is understood to be a unit that includes a sun gear, a ring gear and multiple planet gears guided by a planet carrier on a circular path around the sun gear, wherein the planet gears are meshed with the ring gear and the sun gear.

Preferably, a first sun gear of the first planetary gear set is designed to be connected to the input shaft for conjoint rotation when the drive train is in the installed state. Further preferably, a first planet carrier of the first planetary gear set is designed to be at least indirectly connected to the first output shaft for conjoint rotation. In addition, a first ring gear of the first planetary gear set is preferably at least indirectly connected to a second sun gear of the second planetary gear set for conjoint rotation. A second ring gear of the second planetary gear set is also preferably designed to be at least indirectly connected to the second output shaft for conjoint rotation. The planet carrier of the second planetary gear set, which is also referred to in the following as the second planet carrier, is non-rotatably connected to the housing part.

According to one exemplary embodiment, the first planet carrier is connected to the first output shaft for conjoint rotation via a spline. The spline is provided for supporting and transmitting a torque and a rotational speed. The spline implements a separable connection between the first planet carrier and the first output shaft, and the spline can operatively transmit, or support, a torque and a rotational speed during operation.

A housing part is understood to be a rotationally and axially fixed component of the transmission, for example, the transmission housing itself, a transmission housing part, or a cover of the transmission housing. Components which are supported against the housing part are therefore secured to the housing. The phrase “secured to the housing” is understood to mean that relative motion does not takes place or cannot take place between the component and the housing part of the transmission.

When two components of the transmission are “connected,” or “coupled,” for conjoint rotation, or “are connected to one another,” this means, as set forth in the invention, that these components are permanently coupled such that they cannot rotate independently of one another. This is understood to also mean a permanent rotary joint. In particular, there are no shift elements between these components, which can be elements in the differential, and/or shafts, and/or a non-rotating component in the transmission. Instead, these components are permanently coupled to one another. An elastically rotating connection between two components is also understood to be permanent, or such that the elements rotate conjointly.

Example aspects of the invention include the technical teaching that the transmission also has a carrier element, which is connected to the second output shaft for conjoint rotation and operatively connects the second planetary gear set to the second output shaft. In the event that the second ring gear of the second planetary gear set is at least indirectly connected to the second output shaft for conjoint rotation, the carrier element is to be understood as a coupling shaft, in particular as a ring gear carrier of the second ring gear. The second ring gear of the second planetary gear set is thus connected via the ring gear carrier to the second output shaft for conjoint rotation. It is conceivable that the carrier element and the second output shaft are formed in one piece. In this case, the carrier element is part of the second output shaft.

The carrier element is in the form, for example, of a sheet-metal shaped, annular disk-shaped component, which is connected to the second ring gear for conjoint rotation, for example, via a crown gearing or the like. The carrier element can also be connected in one piece, for example, integrally bonded, to the second ring gear of the second planetary gear set or the second output shaft. By the carrier element, a radial offset between the second ring gear and the second output shaft can be compensated for.

Preferably, the carrier element has at least one installation opening. The installation opening is provided so that, after the carrier element, in particular, a carrier element in the form of a ring gear carrier, and the second output shaft have been preinstalled on the housing part, access is provided in order to axially secure the first bearing element when the first bearing element is not accessible or is accessible only with great difficulty through the housing part and/or the carrier element. In particular, the installation opening is designed such that a screw and an appropriate screwdriving tool can be guided through the installation opening in order to fasten the separate retaining element on the housing part. In this sense, the carrier element preferably has multiple installation openings which are distributed over the circumference in order to be able to fasten the retaining element, which is situated behind the carrier element, on the housing part using screws.

Preferably, a press fit exists between the first bearing element and the second output shaft. It is also conceivable that the carrier element has an axial portion, via which the carrier element is connected to the second output shaft for conjoint rotation. In this case, the first bearing element can also be arranged directly on the carrier element and appropriately axially secured. In this case, a press fit exists between the first bearing element and the carrier element.

The first axial securing retainer is preferably a securing ring. Therefore, the first bearing element is axially securable on the second output shaft via a securing ring. The securing ring is arranged in an at least partially circumferential groove in the outer circumference of the second output shaft, as a result of which the first bearing element can be axially secured on the second output shaft in a simple and space-saving manner.

The phrase “operatively connected” is understood to mean a permanent connection between two components, the permanent connection being provided for permanently transmitting a drive power, in particular a rotational speed and/or a torque. The connection can be established directly or via a fixed ratio. The connection can be established, for example, via a fixed shaft, a toothing, in particular a spur gear tooth system, and/or a wrap-around mechanism.

The phrase “at least indirectly” is to be understood to mean that two components are (operatively) connected to one another via at least one other component, which is arranged between the two components, or that the two components are directly connected to one another. Therefore, even more components can be arranged between shafts, gear wheels or connecting elements, the components being operatively connected to the shaft or to the gear wheel or to the connecting element.

According to a second example aspect of the invention, a method is provided for installing a transmission according to the first example aspect of the invention. This installation method includes:
preinstalling the first bearing element at least indirectly on the second output shaft, the first bearing element coming to rest axially against the first axial stop and being axially secured on the second output shaft by a first axial securing retainer;
loosely arranging the second axial securing retainer, which is in the form of a second retaining element, on the first bearing element and/or on the second output shaft;
inserting the first bearing element into the housing part, the first bearing element coming to rest axially against the second axial stop on the housing part; and
screwing the retaining element on the housing part, such that the first bearing element is axially secured.

Accordingly, the first bearing element is initially preinstalled on the second output shaft, preferably via an interference fit. During the implementation of the interference fit, the first bearing element comes to rest against the first axial stop and, thereafter, is axially secured by the first axial securing retainer, which is preferably in the form of a securing ring. Accordingly, the first bearing element is pressed onto the second output shaft during the preinstallation and prior to being axially secured, such that a preassembled component arises.

Thereafter, this preassembled component, together with the separate retaining element, which is provided as a second axial securing retainer, is inserted into the housing part, and the first bearing element is accommodated via the outer circumference on the housing part. Preferably, the second output shaft is connected to a carrier element for conjoint rotation prior to or during the preinstallation of the first bearing element at least indirectly on the second output shaft, the carrier element having at least one installation opening. During the insertion of the preassembled component into the housing part, the separate retaining element is arranged spatially, in particular axially, between the carrier element, which extends substantially radially, and an axial end face of the housing part.

Once the first bearing element has come to rest against the second axial stop, the separate retaining element is positioned, for example, by rotating the second output shaft with the carrier element, which is arranged thereon for conjoint rotation, about the axis of rotation until an installation opening in the carrier element is aligned, in each case, with a through-hole in the retaining element and a threaded hole in the housing part. Subsequent thereto, a screw is guided through the installation opening and screwed into the threaded hole. In this sense, it is preferred that, when the first bearing element comes to rest against the second axial stop on the housing part when the first bearing element is inserted into the housing part, the retaining element is screwed on the housing part through the respective installation opening in order to axially secure the first bearing element on the housing part.

A drive train for a vehicle according to a third example aspect of the invention includes a transmission as described above, an input shaft, a first output shaft and a second output shaft, the differential of the transmission being operatively arranged between the input shaft and the two output shafts and dividing a drive power, which is applied at the input shaft, onto the two output shafts.

When the drive train is installed, the transmission is therefore operatively connected via the input shaft to the drive unit. The drive unit is preferably an electric machine, and the input shaft of the drive unit is a rotor of the electric machine or is connected, or coupled, to the rotor or to a rotor shaft of the electric machine for conjoint rotation. The rotor is mounted for rotation with respect to a stator of the electric machine, the stator being secured to the housing. The electric machine is preferably connected to an energy store, which supplies the electric machine with electrical energy. Furthermore, the electric machine is preferably controllable by way of an open-loop or closed-loop system by a power electronics system. Alternatively, the drive unit can also be an internal combustion engine, wherein the input shaft in this case is, for example, a crankshaft, or is connected, or coupled, to the crankshaft for conjoint rotation.

The input shaft is preferably in the form of a hollow shaft. As a result, one of the output shafts, in particular the first output shaft, can extend axially through the input shaft. Preferably, one of the output shafts, in particular the first output shaft, extends through the transmission and potentially through the drive unit in the drive train. Therefore, the respective output shaft extends through the transmission “inline” in order to transmit a drive power onto the wheel of the vehicle, which is operatively connected to the output shaft. The output shafts in this case are coaxial, which positively affects the necessary radial installation space. Due to the coaxial arrangement of the output shafts, a radially compact design of the transmission can therefore be achieved. An arrangement in which the output shafts are parallel to and offset from one another is also conceivable and is implementable by appropriate gear stages.

The output shafts of the drive train are designed, in particular, to be operatively connected to a wheel of the vehicle. The respective output shaft can be connected to the associated wheel directly or indirectly, i.e., for example, via a joint and/or a wheel hub.

The drive train according to example aspects of the invention is usable in a vehicle. Therefore, a vehicle has at least one such drive train. The vehicle is preferably a motor vehicle, in particular an automobile (for example, a passenger car having a weight of less than three and half tons (3.5 t)), a bus, or a truck (bus and truck, for example, having a weight of over three and half tons (3.5 t)). In particular, the vehicle is an electric vehicle or hybrid vehicle. The vehicle has at least two axles, wherein one of the axles is formed by an axle that is drivable by the drive train. The drive train according to example aspects of the invention is operatively arranged on this drivable axle and the drive train transmits a drive power from the drive unit onto the wheels on this axle via the transmission according to example aspects of the invention. It is also conceivable to provide such a drive train for each axle. The drive train is preferably front-wheel drive, such that the input shaft and the output shafts are substantially transverse to the longitudinal axis of the vehicle. Alternatively, the drive train can be arranged obliquely with respect to the longitudinal and transverse axes of the vehicle, the output shafts being connected via appropriate joints to the wheels of the respective axle and arranged transversely to the longitudinal axis of the vehicle.

The above definitions and explanations of the technological effects, advantages and advantageous embodiments of the transmission according to the first example aspect of the invention also apply analogously to the method for installing such a transmission according to the second example aspect of the invention, and to the drive train according to example aspects the invention, suca as according to the third example aspect of the invention, and vice versa.

### BRIEF DESCRIPTION OF THE DRAWINGS

An exemplary embodiment of the invention is explained in greater detail in the following with reference to the schematic drawings, in which identical or similar elements are provided with the same reference characters, wherein:

FIG. 1 shows a highly schematic top view of an exemplary vehicle with a drive train according to example aspects of the invention and a transmission according to example aspects of the invention, according to one preferred embodiment, and

FIG. 2 shows a highly simplified view of the transmission according to example aspects of the invention as shown in FIG. 1, and

FIG. 3 shows a schematic partial longitudinal sectional view of the transmission according to example aspects of the invention as shown in FIG. 1 and FIG. 2.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

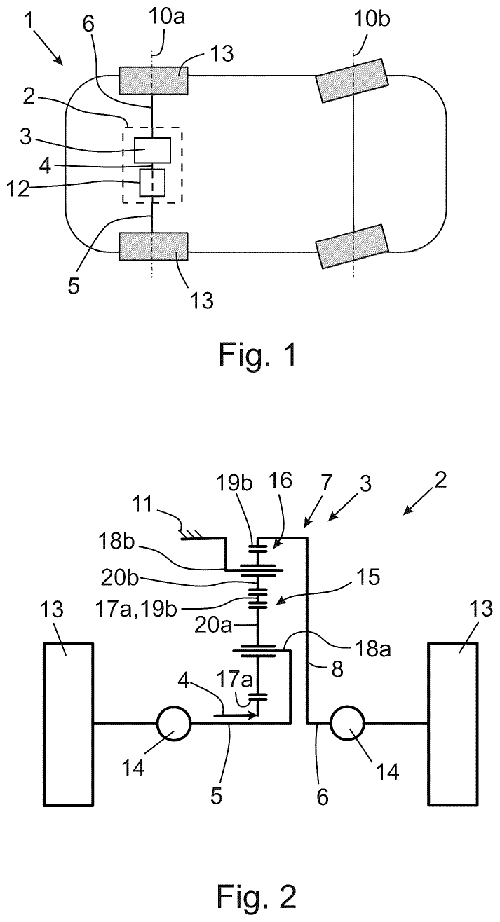

FIG. 1 shows a vehicle 1 with two axles 10a, 10b, wherein a drive train 2 according to example aspects of the invention is drivingly arranged at the first axle 10a. The vehicle 1 is an electric vehicle in this case, the vehicle 1 being driven purely electrically. The first axle 10a can be either the front axle or the rear axle of the vehicle 1 and forms a driven axle of the vehicle 1. In this case, the drive train 2 is arranged, for example, on a non-steerable rear axle of the vehicle 1.

The drive train 2 includes a drive unit 12, which is in the form of an electric machine, and a transmission 3 which is operatively connected thereto. The design and the arrangement of the transmission 3 are explained in greater detail in the following figures. The detailed design of the drive unit 12 is not shown here. The drive unit 12, or the electric machine, also has an accumulator, which supplies the drive unit 12 with electrical energy, and a power electronics system for the open-loop control and closed-loop control of the drive unit 12. A rotor (not shown here), which is arranged so as to be rotatable with respect to the stator and is connected to an input shaft 4 (indicated as an arrow in FIG. 2) for conjoint rotation, is set into a rotational movement relative to the stator by energizing the stator (not shown here). The input shaft 4 is to be understood as a drive shaft which introduces a drive power of the drive unit 12 into the transmission 3, the drive power being converted by a differential 7, which is in the form of an integral differential, and divided onto a first output shaft 5 and a second output shaft 6.

The drive unit 12 is coaxial to the integral differential 7. Similarly, the output shafts 5, 6 are coaxial to each other and to the drive unit 12 and, when the drive train 2 is installed, extend from the transmission 3 in opposite directions to wheels 13 on the first axle 10a. As shown in FIG. 2, joints 14 are arranged between the respective wheel 13 and the output shafts 5, 6 in order to compensate for possible inclinations of the output shafts 5, 6 with respect to wheel hubs (not shown) on the first axle 10a.

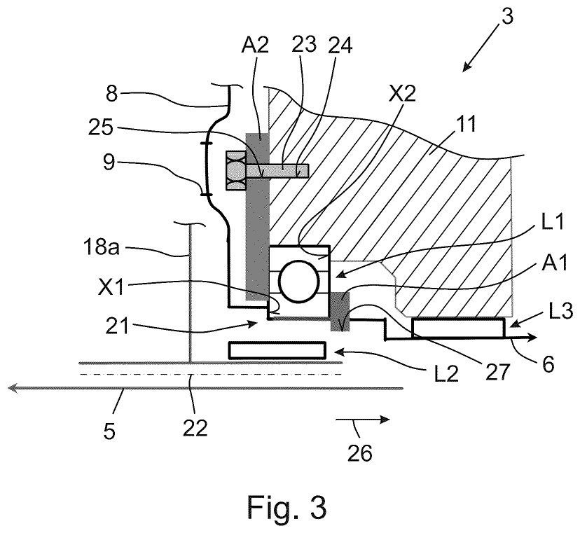

The transmission 3 which is shown in FIG. 2 and partially shown in FIG. 3 is a differential gear. The differential 7 has two planetary gear sets 15, 16, each of which has multiple gear set elements. By the first planetary gear set 15, a first output torque is transmittable onto the first output shaft 5. A support torque of the first planetary gear set 15 is convertible in the second planetary gear set 16 such that a second output torque, which corresponds to the first output torque, is transmittable onto the second output shaft 6.

The first planetary gear set 15 and the second planetary gear set 16 are each in the form of a negative planetary gear set and are radially nested, i.e., arranged in a common plane, the common plane extending perpendicularly to the axle 10a. As a result, axial installation space of the transmission 3 is reduced. The first planetary gear set 15 is arranged radially inside the second planetary gear set 16 in the present case.

On the first planetary gear 15, the first gear set element is a first sun gear 17a, the second gear set element is a first planet carrier 18a and the third gear set element is a first ring gear 19a. On the first planet carrier 18a, multiple first planet gears 20a are rotatably mounted on planet shafts (not shown here). The first planet gears 20a are meshed with the first sun gear 17a and with the first ring gear 19a.

The first output shaft 5 extends axially through the transmission 3, in particular through the integral differential 7, and through the drive unit 12. Accordingly, the first output shaft 5 also extends axially through the first sun gear 17a of the first planetary gear set 15. Therefore, the first sun gear 17a is in the form of a gear wheel which is hollow inside, and the input shaft 4, which is connected to the first sun gear for conjoint rotation, is in the form of a hollow shaft.

On the second planetary gear set 16, the first gear set element is a second sun gear 17b, the second gear set element is a second planet carrier 18b and the third gear set element is a second ring gear 19b. On the second planet carrier 18b, multiple second planet gears 20b are rotatably mounted on planet shafts (not shown here). The second planet gears 20b are meshed with the second sun gear 17b and with the second ring gear 19b.

The first sun gear 17a of the first planetary gear set 15 is designed to be connected to the input shaft 4 for conjoint rotation when the drive train 2 is in the installed state. The first planet carrier 18a of the first planetary gear set 15 is designed to be connected via a spline 22 to the first output shaft 5 for conjoint rotation when the drive train 2 is in the installed state. This is shown in FIG. 3. The first ring gear 19a of the first planetary gear set 15 is connected to the second sun gear 17b of the second planetary gear set 16 in one piece in this case, for conjoint rotation. In addition, the second ring gear 19b of the second planetary gear set 16 is connected to the second output shaft 6 for conjoint rotation via an annular disk-shaped carrier element 9, which is in the form of a ring gear carrier in this case.

It is explicitly pointed out that the assignment of the gear set elements to the elements of the respective planetary gear set 15, 16 can be arbitrarily interchanged. The respective connection of the gear set elements sun gear, planet carrier and ring gear is established depending on the requirement on the transmission ratios, including signs. Instead of a negative planetary gear set, the respective planetary gear set 15, 16 can also always be in the form of a positive planetary gear set by interchanging the connection of the first planet carrier and the first ring gear and increasing the absolute value of the stationary gear ratio by one (1). By analogy, this is also possible vice versa. It is also conceivable to arrange an additional gear stage between the drive unit 12 and the transmission 3, which is in the form, for example, of a spur gear stage or a planetary transmission having one or multiple planetary gear set(s), in order to increase a stationary gear ratio of the drive.

As shown in FIG. 3, the second output shaft 6 is rotatably mounted on a housing part 11 via a first bearing element L1, which is in the form of a grooved ball bearing. The second output shaft 6 is connected to a carrier element 8 for conjoint rotation. The carrier element 8 has multiple installation openings 9, which are distributed over the circumference. Only one installation opening 9 is shown here by way of example. The installation opening 9 is designed such that a screw 23 and a screwdriving tool (not shown here) can be guided through the installation opening 9.

Furthermore, the first output shaft 5 and the second output shaft 6 are mounted so as to be rotatable with respect to each other via a second bearing element L2, which is in the form of a needle bearing. In addition, the second output shaft 6 is rotatably mounted on the housing part 11 via a third bearing element L3, which is also in the form of a needle bearing. The second bearing element L2 and the third bearing element L4 are floating mountings and, if necessary, can both be in the form of a plain bearing, or only one thereof can be in the form of a plain bearing.

FIG. 3 shows the transmission 3 according to a method according to example aspects of the invention for installing the transmission 3. Accordingly, the first bearing element L1, specifically the inner ring of the first bearing element, is first pressed onto the second output shaft 6 in order to generate a press fit 21 and, in fact, is pressed so far that the first bearing element L1 comes to rest axially against the first axial stop X1. Thereafter, the first bearing element L1 is axially secured on the second output shaft 6 by a first axial securing retainer A1 which is in the form of a securing ring. The securing ring comes to rest in a groove 27 in the second output shaft 6.

The second axial securing retainer A2 of the first bearing element L1 is in the form of a separate retaining element which is in the form of a retaining plate. This retaining plate is loosely placed or arranged axially between the housing part 11 and the carrier element 8 before the first bearing element L1, in particular the outer ring of the first bearing element L1, is inserted into the housing part 11 in the installation direction, which is indicated by the arrow 26, until the first bearing element L1 comes to rest axially against the second axial stop X2. The loose retaining plate can be held on the first bearing element L1 or on the second output shaft 6 before the retaining plate is screwed on the housing part 11.

Once the first bearing element L1 has come to rest against the second axial stop X2, the carrier element 8 and the retaining plate are rotatively positioned with respect to each other until an installation opening 9 in the carrier element 8 is aligned, in each case, with a through-hole 25 in the second axial securing retainer A2, or the retaining plate, and with a threaded hole 24 in the housing part 11. Thereafter, a screw 23 is guided through the installation opening 9 and the through-hole 25 and is screwed on the housing part 11 by a screwdriver tool (not shown here), such that the first bearing element L1 is axially secured.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 vehicle
2 drive train
3 transmission
4 input shaft
5 first output shaft
6 second output shaft
7 differential
8 carrier element
9 installation opening
10a first axle
10b second axle
11 housing part
12 drive unit
13 wheel
14 joint
15 first planetary gear set
16 second planetary gear set
17a first sun gear of the first planetary gear set
17b second sun gear of the second planetary gear set
18a first planet carrier of the first planetary gear set
18b second planet carrier of the second planetary gear set
19a first ring gear of the first planetary gear set
19b second ring gear of the second planetary gear set
20a first planet gear of the first planetary gear set
20b second planet gear of the second planetary gear set
21 press fit
22 spline
23 screw
24 threaded hole
25 through-hole
26 arrow
27 groove
A1 first axial securing retainer
A2 second axial securing retainer
L1 first bearing element
L2 second bearing element
L3 third bearing element
X1 first axial stop
X2 second axial stop

1-11: (canceled)

12. A transmission (3) for a drive train (2) of a vehicle (1), comprising:
a first output shaft (5);
a second output shaft (6); and
a differential (7) configured to divide a drive power onto the first output shaft (5) and onto the second output shaft (6);
a first bearing element (L1) that at least indirectly rotatably mounts the second output shaft (6) on a housing part (11),
wherein the first bearing element (L1) is axially secured on the second output shaft (6) via a first axial securing retainer (A1) and a first axial stop (X1), and
wherein the first bearing element (L1) is axially secured on the housing part (11) via a second axial securing retainer (A2) and a second axial stop (X2), and
wherein the second axial securing retainer (A2) is a separate retaining element that is fastened on the housing part (11).

13. The transmission (3) of claim 12, wherein:
the differential (7) comprises a first planetary gear set (29) and a second planetary gear set (30) operatively connected to the first planetary gear set (29);
a first output torque is at least indirectly transmittable by the first planetary gear set onto the first output shaft (5);
a support torque of the first planetary gear set (29) is convertible in the second planetary gear set (30) such that a second output torque, which corresponds to the first output torque, is transmittable onto the second output shaft (6).

14. The transmission (3) of claim 13, further comprising a carrier (8) connected to the second output shaft (6) for conjoint rotation, the carrier (8) operatively connecting the second planetary gear set (30) to the second output shaft (6).

15. The transmission (3) of claim 14, wherein the carrier (8) comprises at least one installation opening (9).

16. The transmission (3) of claim 12, wherein the first bearing element (L1) and the second output shaft (6) are connected by a press fit.

17. The transmission (3) of claim 12, wherein the first axial securing retainer (A1) comprises a securing ring.

18. A drive train (2) for a vehicle (1), comprising:
the transmission (3) of claim 12; and
an input shaft (4),
wherein the differential (7) of the transmission (3) is operatively arranged between the input shaft (4) and the first and second output shafts (5, 6) such that the differential (7) is configured to divide a drive power applied at the input shaft (4) onto the first and second output shafts (5, 6).

19. A method for installation for the transmission (3) of claim 12, comprising:
preinstalling the first bearing element (L1) at least indirectly on the second output shaft (6), the first bearing element (L1) coming to rest axially against the first axial stop (X1) and axially secured on the second output shaft (6) by the first axial securing retainer (A1);
loosely arranging the second axial securing retainer on one or both of the first bearing element (L1) and the second output shaft (6);
inserting the first bearing element (L1) into the housing part (11), the first bearing element (L1) coming to rest axially against the second axial stop (X2) on the housing part (11); and
fastening the second axial securing retainer (A2) on the housing part (11) such that the first bearing element (L1) is axially secured.

20. The method of claim 19, wherein the first bearing element (L1) is pressed onto the second output shaft (6) during the preinstallation and prior to being axially secured.

21. The method of claim 19, wherein the second output shaft (6) is connected to a carrier (8) for conjoint rotation prior to or during the preinstallation, wherein the carrier element (8) comprises an installation opening (9).

22. The method of claim 21, wherein, when the first bearing element (L1) comes to rest against the second axial stop (X2) on the housing part (11) during insertion of the first bearing element into the housing part (11), the second axial securing retainer (A2) is fastened on the housing part (11) through the installation opening (9) in order to axially secure the first bearing element (L1) on the housing part (11).
